(19) United States
(12) Patent Application Publication
(10) Pub. No.: US 2022/0210500 A1
(43) Pub. Date: Jun. 30, 2022

(54) METHOD FOR CONTROLLING DISPLAY OF MULTIMEDIA DATA, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Liyao SUN, Beijing (CN); Xiaobo ZHANG, Beijing (CN); Rong WANG, Beijing (CN); Qiyu SUN, Beijing (CN)

(21) Appl. No.: 17/495,508

(22) Filed: Oct. 6, 2021

(30) Foreign Application Priority Data
Dec. 25, 2020 (CN) 202011569047.1

(51) Int. Cl. H04N 21/431; H04N 21/2665; G06F 3/0488; G06F 3/0484

(52) U.S. Cl. CPC H04N 21/4316; H04N 21/4314; G06F 3/04842; G06F 3/04886; H04N 21/2665

(57) ABSTRACT

The disclosure relates to systems, apparatuses, methods, and non-transitory-computer readable media for controlling display of multimedia data including receiving a plurality of multimedia data streams distributed by a server-side, playing the plurality of multimedia data streams in a plurality of display areas of a graphical user interface, respectively, selecting a target multimedia data stream from the plurality of multimedia data streams, and adjusting the default display mode to a target display mode based on the target multimedia data stream. The plurality of multimedia data streams are data streams respectively provided by a plurality of anchor client-sides. In a default display mode, each of the plurality of display areas is a preset ratio display area in the graphical user interface. The target multimedia data stream comprises one or more multimedia data streams.

### CROSS-REFERENCE TO RELATED APPLICATIONS

This disclosure claims priority to Chinese Patent Application No. 202011569047.1, titled “METHOD FOR CONTROLLING DISPLAY OF MULTIMEDIA DATA, ELECTRONIC DEVICE, AND STORAGE MEDIUM,” filed with China National Intellectual Property Administration on Dec. 25, 2020, the content of which is incorporated herein by reference in its entirety.

### TECHNICAL FIELD

The disclosure relates to the field of multimedia data technology, and in particular, to systems, apparatuses, methods, and non-transitory computer-readable media for controlling display of multimedia data.

### BACKGROUND

As mobile live streaming applications become increasingly widespread, many novel live streaming mechanisms have been implemented for live streaming applications, including for example, a live streaming MicLink (i.e., linking microphones) Player Kill (PK) (versus mode match). However, in the traditional live streaming MicLink PK, there are usually multiple (e.g., two) anchors participating in the match and hosting the respective show in the same interface, and the audience-side can watch shows of the actions of those two anchors in the PK stage in the live streaming. When the audience is watching the PK live streaming, the audience cannot control the live streaming interface.

### SUMMARY

According some arrangements, a method for controlling display of multimedia data is applied to an audience client-side and may include receiving a plurality of multimedia data streams distributed by a server-side. The plurality of multimedia data streams are data streams respectively provided by a plurality of anchor client-sides. The method further includes playing the plurality of multimedia data streams in a plurality of display areas of a graphical user interface, respectively. In a default display mode, each of the plurality of display areas is a preset ratio display area in the graphical user interface. The method further includes selecting a target multimedia data stream from the plurality of multimedia data streams. The target multimedia data stream comprises one or more multimedia data streams. The method further includes and adjusting the default display mode to a target display mode based on the target multimedia data stream.

According some arrangements, an apparatus for controlling display of multimedia data is applied to an audience client-side and may include a receiving unit configured to receive a plurality of multimedia data streams distributed by a server-side. The plurality of multimedia data streams are data streams respectively provided by a plurality of anchor client-sides. The apparatus further includes a playing unit configured to play the plurality of multimedia data streams in a plurality of display areas of a graphical user interface, respectively, where in a default display mode, each of the plurality of display areas is a preset ratio display area in the graphical user interface. The apparatus further includes a selection unit configured to select a target multimedia data stream from the plurality of multimedia data streams, where the target multimedia data stream comprises one or more multimedia data streams. The apparatus further includes a control unit configured to adjust the default display mode to a target display mode based on the target multimedia data stream.

According to an aspect of the disclosure, an electronic device is applied to an audience client-side and may include a processor and a memory for storing instructions executable by the processor The processor is configured to receive a plurality of multimedia data streams distributed by a server-side, play the plurality of multimedia data streams in a plurality of display areas of a graphical user interface, respectively, select a target multimedia data stream from the plurality of multimedia data streams, and adjust the default display mode to a target display mode based on the target multimedia data stream. The plurality of multimedia data streams are data streams respectively provided by a plurality of anchor client-sides. In a default display mode, each of the plurality of display areas is a preset ratio display area in the graphical user interface. The target multimedia data stream comprises one or more multimedia data streams.

According to some arrangements, non-transitory computer-readable storage media having instructions stored thereon, such that when performed by a processor, a method for controlling display of multimedia data is performed. The method for controlling display of multimedia data may include receiving a plurality of multimedia data streams distributed by a server-side, playing the plurality of multimedia data streams in a plurality of display areas of a graphical user interface, respectively, selecting a target multimedia data stream from the plurality of multimedia data streams, and adjusting the default display mode to a target display mode based on the target multimedia data stream. The plurality of multimedia data streams are data streams respectively provided by a plurality of anchor client-sides. In a default display mode, each of the plurality of display areas is a preset ratio display area in the graphical user interface. The target multimedia data stream comprises one or more multimedia data streams.

According some arrangements, there is provided a computer program product including instructions, the instructions are executed by the computer, so that the computer executes a method for controlling display of multimedia data arrangement as described herein.

### BRIEF DESCRIPTION OF THE DRAWINGS

The drawings described herein are used to provide a further understanding of the present disclosure and constitute a part of the present disclosure. The some arrangements of the present disclosure and their descriptions are used to explain the present disclosure, and do not constitute an improper limitation of the present disclosure. In the drawings:

FIG. 1 is a flowchart showing a method for controlling display of multimedia data according to some arrangements.

FIG. 2 is a schematic diagram showing a live streaming PK interface according to some arrangements.

FIG. 3 is a schematic diagram showing a live streaming PK interface according to some arrangements.

FIG. 4 is a schematic diagram showing a live streaming PK interface according to some arrangements.

FIG. 5 is a schematic diagram showing a live streaming PK interface according to some arrangements.

FIG. 6 is a schematic diagram showing a live streaming PK interface according to some arrangements.

FIG. 7 is a schematic diagram showing a live streaming PK interface according to some arrangements.

FIG. 8 is a flow chart showing a process of watching live streaming PK and switching viewing angles of the live streaming according to some arrangements.

FIG. 9 is a flow chart showing a process of pulling streaming and combining streaming during live streaming PK according to some arrangements.

FIG. 10 is a flowchart showing a process of combining streaming when watching two anchors according to some arrangements.

FIG. 11 is a flow chart showing a implementation process of watching one anchor according to some arrangements;

FIG. 12 is a block diagram showing an apparatus for controlling display of multimedia data according to some arrangements.

FIG. 13 is a block diagram showing an electronic device according to some arrangements.

### DETAILED DESCRIPTION

In order to enable those of ordinary skill in the art to better understand the technical solutions of the disclosure, the technical solutions in the arrangements of the present disclosure will be described clearly and completely in conjunction with the accompanying drawings in the arrangements of the present disclosure. Obviously, the described arrangements are only a part of the arrangements of the present disclosure, but not all of the arrangements. Based on the arrangements in the present disclosure, all other arrangements obtained by those of ordinary skill in the art without creative work should fall within the protection scope of the present disclosure.

It should be noted that the terms “first” and “second” in the specification and claims of the disclosure and the above-mentioned drawings are used to distinguish similar objects, and not necessarily used to describe a specific sequence or order. It should be understood that the data used in this way can be interchanged under appropriate circumstances, so that the arrangements of the disclosure described herein can be implemented in an order other than those illustrated or described herein. In addition, the terms “including” and “having” and any variations of them are intended to cover non-exclusive inclusions. For example, a process, method, system, product, or device that includes a series of steps or units is not necessarily limited to those clearly listed. Those steps or units may include other steps or units that are not clearly listed or are inherent to these processes, methods, products, or devices.

In order to enable those of ordinary skill in the art to better understand the technical solutions of the present disclosure, the technical solutions in the arrangements of the present disclosure will be described clearly and completely with reference to the accompanying drawings.

The implementation manners described in the following some arrangements do not represent all implementation manners consistent with the present disclosure. Rather, they are merely examples of devices and methods consistent with some aspects of the present disclosure as detailed in the appended claims.

In the traditional live streaming MicLink PK room, when the audience is watching a PK live streaming picture, the audience cannot control the live streaming interface. As a result, the audience can only watch the live streaming interface presented on the platform, which consumes more computing performance and is more likely to cause stucking and heating.

Furthermore, in the traditional live streaming MicLink PK room, it is not possible for the audience only watch the anchor that he/she supports and not to watch the anchor supported by the counterpart. As a result, the audience cannot obtain a pure viewing experience, which indirectly affects the audience's desire to spend on gifts. Therefore, technical solutions are adopted in the arrangements of the present application to improve the viewing experience of the audience in the PK live streaming room and increase the revenue of the anchor/live streaming platform.

The existing PK live streaming scheme is that two anchors respectively mix his/her own streaming and the other's streaming into one streaming, and send the one streaming to the audience via a content delivery network (CDN). Therefore, what the audience watched is a mixed streaming picture, because the streaming watched by the audience is an already mixed stream, it is impossible to shield pictures and sound coming from the counterpart. The above-mentioned existing technical solutions not only affect the viewing experience of the audience-side in the PK live streaming room, but also consume more computing performance by the mixed streaming at the anchor-side, thus it is more likely to cause stalls, heating, etc. In order to solve the above-mentioned existing technologies problem, the present disclosure provides a method for controlling display of multimedia data.

FIG. 1 is a flowchart showing a method for controlling display of multimedia data according to some arrangements. The method for controlling display of multimedia data is applied to an audience client-side. As shown in FIG. 1, the method for controlling display of multimedia data includes following:

receiving (S11) a plurality of multimedia data streams distributed by a server-side, wherein the plurality of multimedia data streams are data streams respectively provided by a plurality of anchor client-sides;

playing (S12) the plurality of multimedia data streams in a plurality of display areas of a graphical user interface, respectively, wherein, in a default display mode, each of the plurality of display areas is a preset ratio display area in the graphical user interface;

selecting (S13) a target multimedia data stream from the plurality of multimedia data streams, wherein the target multimedia data stream comprises one or more multimedia data streams;

based on the target multimedia data stream, adjusting (S14) the default display mode to a target display mode.

In the arrangements of the present disclosure, by using the above-mentioned method that receiving the plurality of multimedia data streams distributed by the server-side, wherein the plurality of multimedia data streams are data streams respectively provided by a plurality of clients; playing the plurality of multimedia data streams in a plurality of display areas of a graphical user interface, respectively, wherein, in the default display mode, each of the above-mentioned plurality of display areas is a preset ratio display area in the graphical user interface; selecting a target multimedia data stream from the above-mentioned plurality of multimedia data streams, wherein the target multimedia data stream comprises one or more multimedia data streams; adjusting the above-mentioned default display mode to the target display mode based on the above-mentioned target multimedia data stream, the purpose of controlling the display of live streaming picture on the audience-side can be achieved, thereby improving experience feeling of the audiences in the live streaming MicLink PK room, and further solving the technical problems that the traditional live streaming MicLink PK room adopts a live streaming method of mixing the view streaming, which makes the audience cannot control the display of the live streaming picture.

In the arrangement of the present disclosure, the execution body of the foregoing method for controlling display of multimedia data is a client-side, for example, any kind of live streaming client-side or an audience client-side. The foregoing server-side may distribute a first multimedia data stream and a second multimedia data stream to the audience client-side through the content distribution network (CDN).

In some arrangements, the plurality of anchor client-sides are multiple identical or different anchor client-sides. Taking the plurality of anchor client-sides are N (N≥3) anchor client-sides as an example, the corresponding multimedia data streams are N (N≥3). For example, the first multimedia data stream among the N multimedia data streams is a data stream pushed by a first anchor client-side to the server-side. The second multimedia data stream among the N multimedia data streams is a data stream pushed by a second anchor client-side to the server-side. The third multimedia data stream among the N multimedia data streams is a data stream pushed by a third anchor client-side to the server-side, and so on.

In the arrangement of the present application, the live streaming audience client-side respectively plays the plurality of multimedia data streams in multiple display areas of the graphical user interface (for example, a live streaming PK interface). In some arrangements, in the default display mode, each of the multiple display areas is the preset ratio display area in the graphical user interface. For example, the multiple display areas may be all equal display areas or non-equal display areas.

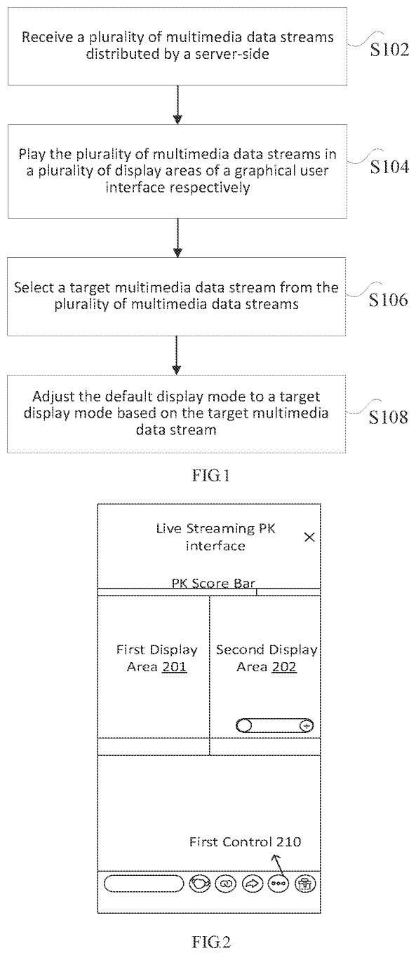

In some arrangements, the above-mentioned multiple display areas may be a first display area 201 and a second display area 202 as shown in FIG. 2, and may also be a first display area 301, a second display area 302, a third display area 303 and a fourth display area 304 as shown in FIG. 4. In some arrangements, the preset ratio display way of the multiple display areas may include, but are not limited to, side-by-side display left and right, side-by-side display up and down, diagonal display, etc.

In the arrangement of the present disclosure, one or more target multimedia data streams can be selected from the plurality of multimedia data streams in response to a touch operation of the audience; and based on the selected one or more target multimedia data streams, the default display mode is adjusted to the target display mode.

By using the arrangements of the present disclosure, the audience can arbitrarily choose to watch only the multimedia data stream of a certain anchor among multiple anchors. For example, it can be a concerned anchor or a non-concerned anchor, or an anchor in the main live streaming room (the main live streaming room can be a live streaming room which the audience enters), which can improve the user experience and save user traffic. The audience can arbitrarily close the multimedia data stream of one or more anchors in the PK, so as to improve the experience of watching the live streaming PK. During the PK process, the anchor-side does not need to mix streaming, which can also avoid mixing the streaming at the anchor client-side, thus achieving the purpose of optimizing the performance of the anchor, and improving the performance of the anchor-side and the stability of the system.

In some arrangements, the selecting the target multimedia data stream from the plurality of multimedia data streams may include:

in response to that a first control in the graphical user interface receiving a first touch operation, displaying (S21) a function setting interface, wherein the first control is independent of the plurality of display areas, and the function setting interface includes a plurality of extended function controls;

in response to that the a second control of the plurality of extended function controls receiving a second touch operation, selecting the target multimedia data stream, wherein the selection of the target multimedia data stream is triggered by the second control.

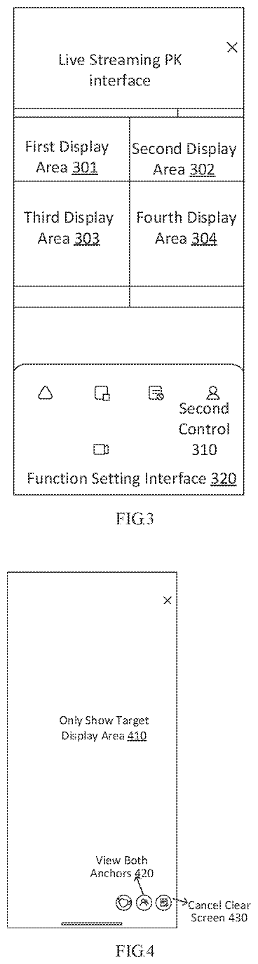

For example, in response to receiving a click operation (i.e., the first touch operation) to ‘More(i.e., ^{ooo})’ button (i.e., the first control 210) in the graphical user interface shown in FIG. 2 from the audience, the function setting interface shown in FIG. 3 is popped-up, that is, more operation panels, such as the function setting interface in FIG. 3. The above-mentioned function setting interface includes the plurality of extended function controls. The audience can click the second control 310 (i.e., a button for just watching the audience) on the function setting interface 320, thus selecting the target multimedia data stream.

In some arrangements, the adjusting the default display mode to the target display mode based on the target multimedia data stream includes:

determining (S31), from the plurality of display areas, a target display area corresponding to the target multimedia data stream and a non-target display area not corresponding to the target multimedia data stream;

displaying (S32) the target display area in a full-screen display based on a display size of the graphical user interface, and hiding the non-target display area.

In the arrangement of the present disclosure, in response to selecting the target multimedia data stream via the function setting interface 320 shown in FIG. 3, said function setting interface 320 is retracted, and the target display area corresponding to the target multimedia data stream and the non-target display area not corresponding to the target multimedia data stream are determined. After that, the target display area of the target multimedia data stream selected by the audience is enlarged in the current live streaming picture, that is, entering the full-screen display as shown in FIG. 4. For example, the full-screen display mode may be a full-screen clear-screen display, that is, only the target display area 410 for the current anchor picture is displayed and the non-target display area except for the target display area for the current anchor picture (for example, elements from other live streaming room) is hidden. As shown in FIG. 4, only the ‘Quick Gift’ button, the ‘View Both anchors’ button 420 and the ‘Cancel Clear Screen’ button 430 are displayed in the target display area.

In some arrangements, this disclosure provides a method for controlling display of multimedia data further includes:

playing (S41) the target multimedia data stream in the target display area in the target display mode, and stopping getting remaining data streams except for the target multimedia data stream from the server-side.

In some arrangements, in response to displaying the target display area in the full-screen display based on the display size of the graphical user interface and hiding the non-target display area, only the target multimedia data stream from the current anchor (i.e., video streams and audio streams) are retained, and obtaining remaining data streams other than the target multimedia data stream from the server-side is stopped.

In some arrangements, the above method further includes:

in response to that a third control in the graphical user interface receiving a third touch operation, restoring (S51) the target display mode to the default display mode, wherein the third control is used to trigger a determination of a display mode of the graphical user interface.

In response to receiving a click operation (i.e., the third touch operation) to ‘View Both Anchor’ button 420 (i.e., the third control) as shown in FIG. 4 from the audience, the current anchor picture is reduced and restored to a normal clear-screen mode 510 as shown in FIG. 5, so as to play the video streams and audio streams of both anchors. In some arrangements, in response to receiving a click operation to the “Cancel Clear Screen” button 430 as shown in FIG. 4 from the audience, the current anchor picture is restored to the default display mode shown in FIG. 2.

In some arrangements, the selecting the target multimedia data stream from the plurality of multimedia data streams may include:

in response to that a fourth control in any one of the plurality of display areas receiving a fourth touch operation, selecting (S61) the target multimedia data stream, wherein the fourth control triggers a selection of the target multimedia data stream.

in response to receiving a click operation (i.e., the fourth touch operation) to ‘Only Watch Live Streaming’ button (i.e., the fourth control) 520 as shown in FIG. 5 from the audience, the current anchor picture is enlarged to the full-screen display, that is, entering the full-screen display mode as shown in FIG. 4, and only the target multimedia data stream of the current anchor is retained.

In some arrangements, the adjusting the default display mode to the target display mode based on the target multimedia data stream includes:

determining (S71), from the plurality of display areas, a main display area corresponding to the target multimedia data stream and an auxiliary display area not corresponding to the target multimedia data stream;

displaying (S72) the main display area in the full-screen display based on the display size of the graphical user interface, and displaying the auxiliary display area in a local window.

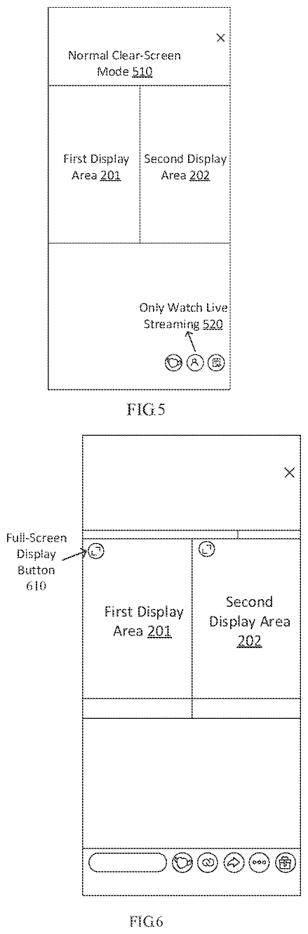

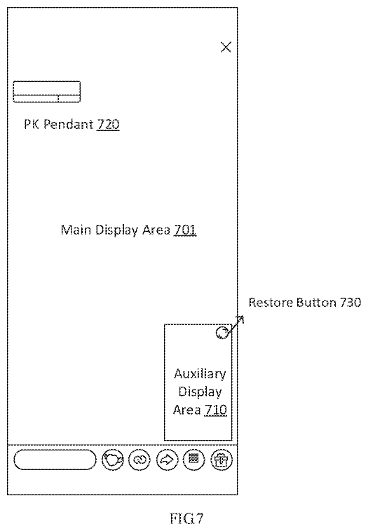

As shown in FIG. 6, a full-screen display button 610 is set in each of the above-mentioned display areas 201 and 202. In response to that the audience clicking the full-screen display button in one of the plurality of display areas, the selected display area is the main display area 701, and the current anchor picture of the main display area 701 is enlarged in the full-screen display, the auxiliary display area 710 is reduced to be displayed in a small window at the lower right corner shown in FIG. 7, or it can also be displayed in a small window at the lower left corner, at the upper left corner, at the upper right corner, at the upper part, and at the bottom part, and so on.

In some arrangements, the method for controlling display of multimedia data the present disclosure further includes:

playing (S81) the target multimedia data stream in the main display area in the target display mode, and playing a multimedia data stream corresponding to the auxiliary display area in the auxiliary display area.

As shown in FIG. 7, the target multimedia data stream is played in the main display area 701 in the target display mode, and the multimedia data stream corresponding to the auxiliary display area 710 is played in the auxiliary display area 710.

In some arrangements, the method for controlling display of multimedia data of the present disclosure further includes:

in response to that a fifth control in the auxiliary display area receiving a fifth touch operation, restoring (S91) the target display mode to the default display mode, wherein the fifth control is used to trigger a determination of a display mode of the graphical user interface.

Still as shown in FIG. 7, in response to receiving a click operation to the ‘Restore’ button 730 in the small window display area as shown in FIG. 7 from the audience, the small window picture is enlarged and restored to the default display mode of the PK picture as shown in FIG. 6, a PK score bar reappears and a PK pendant 720 in the upper left corner is slid to the right and disappears.

In some arrangements, a first anchor client-side (anchor A 801) and a second anchor client-side (anchor B 802) start pushing streaming in the live streaming. For example, a first multimedia data stream is pushed by the first anchor client-side to a media server-side, and a second multimedia data stream is pushed by the second anchor client-side to the media server-side. The first anchor client-side and the second anchor client-side establish a live streaming PK through a process of conducting an invitation or accepting an invitation, and so on, and canvass for the media data stream of the other anchor party while pushing streaming to the media server-side, so as to form and play the live streaming MicLink PK picture.

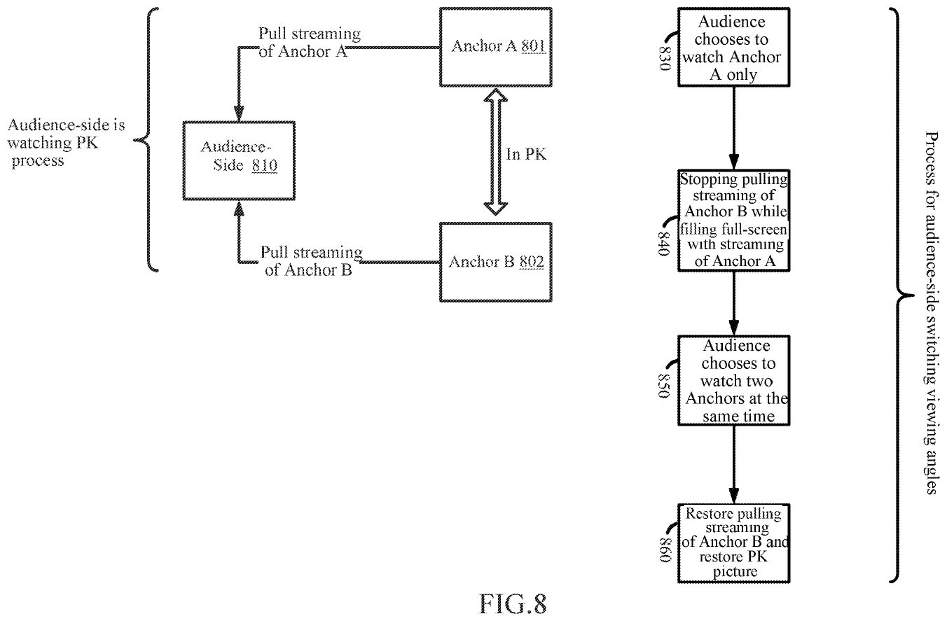

As shown in FIG. 8, in response to the server-side notifying the audience-side 810 that the current live streaming room is connecting to the MicLink PK, the audience-side 810 simultaneously pulls the first multimedia data stream and the second multimedia data stream from the server-side and splices them, and then shows the live streaming MicLink PK picture as shown in FIG. 2 or FIG. 6 at the local client-side (i.e., the audience client-side). At 830, the audience chooses to watch Anchor A 801 only. At 840, in response to 830, the audience stops pulling stream of Anchor B 802 while filling full screen with the streaming of Anchor A 801. At 850, the audience chooses to watch two anchors 801 and 802. At 860, in response to 850, the audience restores pulling stream of Anchor B 802 and restores PK streaming picture.

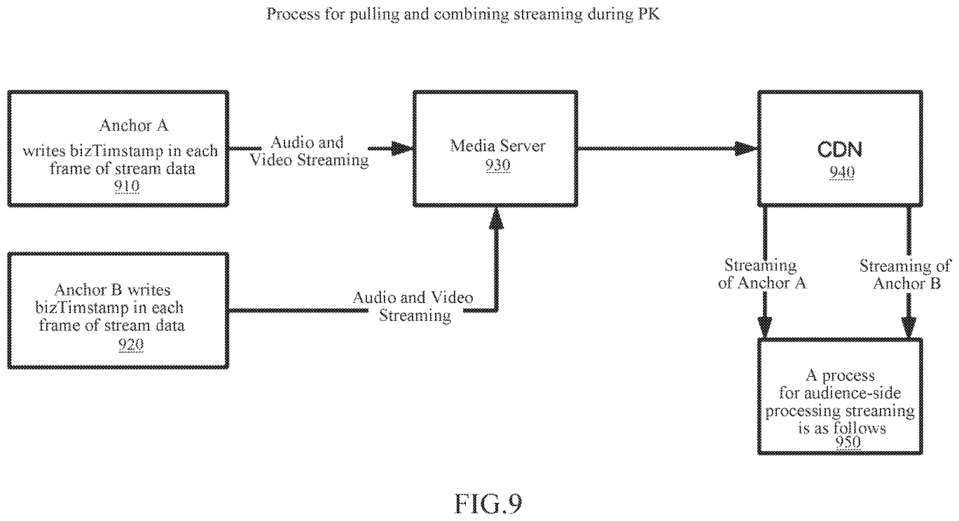

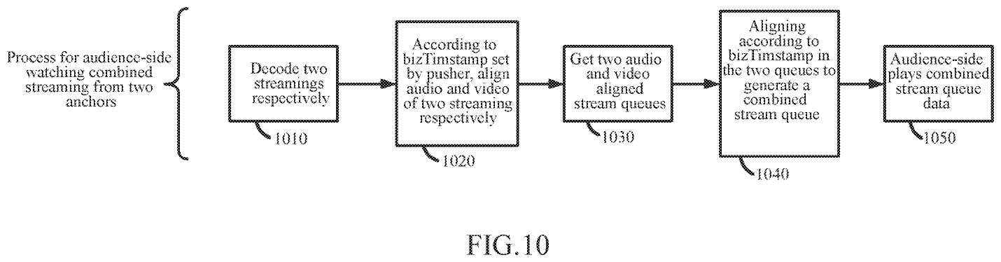

In FIG. 9, Anchor A writes bizTimestamp in each frame of its stream data at 910, and Anchor B writes bizTimestamp in each in its frame of stream data at 920. The audio and video streaming data is provide to a media server 930 and a CDN 940, which process both streams to the audience side, for the audience side to process streaming at 950. In the process of pulling streaming and combining streaming during the PK as shown in FIG. 9, when watching PK between the anchors, the audience-side pulls the first multimedia data stream and the second multimedia data stream at the same time and decode the streamings respectively at 1010, performs an audio and video (A/V) alignment of two streaming, respectively, based on business timestamp (bizTimeStamp) information of the two streaming at 1020, to generate two A/V aligned streaming queues at 1030 and then performs a combination processing to the two A/V aligned streaming queues based on the business timestamp (bizTimeStamp) information 1040, so as to generate a mixed or combined streaming queue data at 1050, and put it into a player for playing to the audience when he/she chooses to only watch the combined streaming of the two anchors, which is shown in FIG. 10.

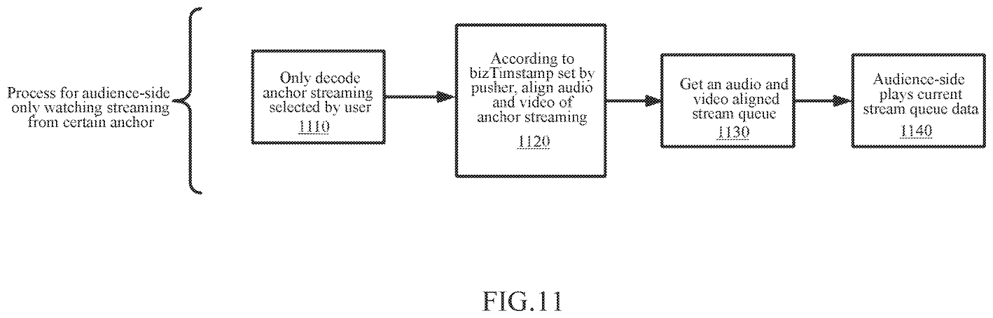

As shown in FIG. 11, when the audience chooses to watch only a certain anchor, a decoding operation 1110 and then an audio and video (A/V) alignment according to bizTimestamp set by pusher 1120 are performed only to audio and video streaming of this anchor while stopping pulling the streaming of the other anchor. Thus, audio and video aligned stream queue is obtained at 1130, and the audience side plays current stream queue data at 1140. For the interactive processing on the screen, the streaming picture of the anchor selected by the user is enlarged and the picture of the other anchor is removed at the same time. In response to the audience clicking the ‘Cancel’ button, pulling the streaming of the other anchor is continued, thus re-performing the combining, and for the interactive processing on the screen, switching back to the picture of the two small windows.

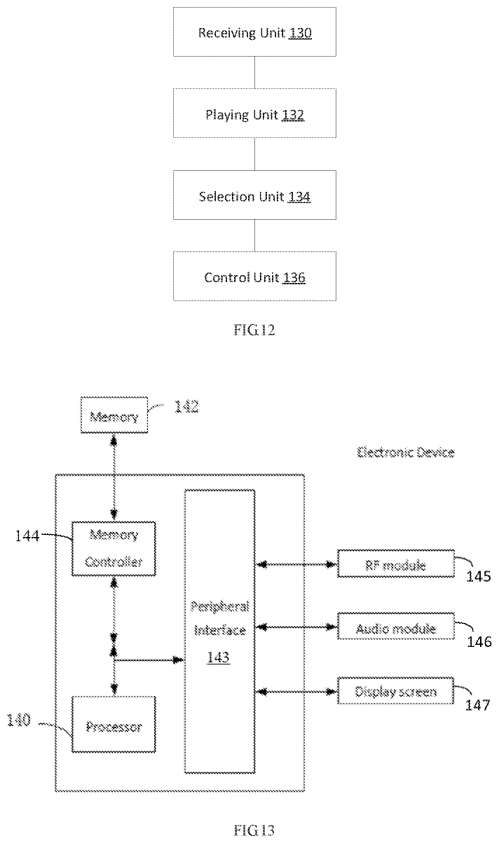

FIG. 12 is a block diagram showing an apparatus for controlling display of multimedia data according to some arrangements. The apparatus for controlling display of multimedia data is applied to an audience client-side. The apparatus may include a receiving unit 130, a playing unit 132, a selection unit 134, and a control unit 136.

The receiving unit 130 is configured to receive a plurality of multimedia data streams distributed by a server-side, wherein the plurality of multimedia data streams are data streams respectively provided by a plurality of anchor client-sides. The playing unit 132 is configured to play the plurality of multimedia data streams in a plurality of display areas of a graphical user interface, respectively, wherein, in a default display mode, each of the plurality of display areas is a preset ratio display area in the graphical user interface. The selection unit 134 is configured to select a target multimedia data stream from the plurality of multimedia data streams, wherein the target multimedia data stream comprises one or more multimedia data streams. The control unit 136 is configured to adjust the default display mode to a target display mode based on the target multimedia data stream.

In some arrangements, the selection unit 134 includes: a display subunit configured to, in response to that a first control in the graphical user interface receiving a first touch operation, display a function setting interface, wherein the first control is independent of the plurality of display areas, and the function setting interface comprises a plurality of extended function controls; and a first selection subunit configured to, in response to that the a second control of the plurality of extended function controls receiving a second touch operation, select the target multimedia data stream, wherein the second control triggers a selection of the target multimedia data stream.

In some arrangements, the control unit 134 includes: a first determining subunit configured to determine, from the plurality of display areas, a target display area corresponding to the target multimedia data stream and a non-target display area not corresponding to the target multimedia data stream; and a first control subunit configured to display the target display area in a full-screen display based on a display size of the graphical user interface, and hide the non-target display area.

In some arrangements, the apparatus for controlling display of multimedia data further includes a first playing control unit configured to play the target multimedia data stream in the target display area in the target display mode, and stop getting remaining data streams except for the target multimedia data stream from the server-side.

In some arrangements, the apparatus for controlling display of multimedia data further includes a restoring unit configured to, in response to that a third control in the graphical user interface receiving a third touch operation, restore the target display mode to the default display mode, wherein the third control triggers a determination of a display mode of the graphical user interface.

In some arrangements, the selection unit 134 includes: a second selection subunit configured to, in response to that a fourth control in any one of the plurality of display areas receiving a fourth touch operation, select the target multimedia data stream, wherein the fourth control triggers a selection of the target multimedia data stream.

In some arrangements, the control unit 134 includes: a second determining subunit configured to determine, from the plurality of display areas, a main display area corresponding to the target multimedia data stream and an auxiliary display area not corresponding to the target multimedia data stream; and a second control subunit configured to display the main display area in a full-screen display based on a display size of the graphical user interface, and display the auxiliary display area in a local window.

In some arrangements, the apparatus for controlling display of multimedia data further includes a second playing control unit configured to play the target multimedia data stream in the main display area in the target display mode, and play a multimedia data stream corresponding to the auxiliary display area in the auxiliary display area.

In some arrangements, the apparatus for controlling display of multimedia data further includes a display restoration unit configured to, in response to that a fifth control in the auxiliary display area receiving a fifth touch operation, restore the target display mode to the default display mode, wherein the fifth control triggers a determination of a display mode of the graphical user interface.

Regarding the apparatus in the foregoing arrangement, the specific manner in which each module performs operation has been described in detail in the arrangement of the method, and detailed description will not be given here.

In the arrangements of the present disclosure, by using the above-mentioned method that receiving the plurality of multimedia data streams distributed by the server-side, wherein the plurality of multimedia data streams are data streams respectively provided by a plurality of anchor client-sides; playing the plurality of multimedia data streams in a plurality of display areas of a graphical user interface, respectively, wherein in the default display mode, each of the above-mentioned plurality of display areas is a preset ratio display area in the graphical user interface; selecting a target multimedia data stream from the above-mentioned plurality of multimedia data streams, wherein the target multimedia data stream comprises one or more multimedia data streams; adjusting the above-mentioned default display mode to the target display mode based on the above-mentioned target multimedia data stream, the purpose of controlling the display of live streaming picture on the audience-side can be achieved, thereby improving experience feeling of the audiences in the live streaming MicLink PK room, and further solving the technical problems that the traditional live streaming MicLink PK room adopts a live streaming method of mixing the view streaming, which makes the audience cannot control the display of the live streaming picture.

FIG. 13 is a block diagram showing an electronic device according to some arrangements. As shown in FIG. 13, the electronic device may include at least one processor 140, a memory 142 and a peripheral interface 143. The memory 142 is controlled by a memory controller 144. The peripheral interface 143 is operatively connected to RF module 145, audio module 146, and display screen 147. The peripheral interface 143 is connected to the processor 140 and the memory controller 144.

In some arrangements, there is also provided a computer-readable storage medium having instructions stored thereon, such as a memory including instructions, which may be executed by a processor of the apparatus to perform the foregoing method. In some arrangements, the computer-readable storage medium may be a non-transitory computer-readable storage medium. For example, the aforementioned non-transitory computer-readable storage medium may be ROM, random access memory (RAM), CD-ROM, magnetic tape, floppy disk, and optical data storage devices, etc.

According to an arrangement of the present disclosure, an arrangement of a non-volatile computer-readable storage medium is also provided. Optionally, in this arrangement, the aforementioned non-volatile computer-readable storage medium includes programs stored therein, wherein, when the aforementioned program is running, the device where the aforementioned non-volatile computer-readable storage medium is located is controlled to execute any one of the aforementioned display control method for multimedia data.

Optionally, in this arrangement, the aforementioned non-volatile computer-readable storage medium may be located in any computer terminal in a computer terminal group in a computer network, or located in any mobile terminal in a mobile terminal group. The non-volatile computer-readable storage medium includes a stored program.

According to an arrangement of the present disclosure, an arrangement of a processor is also provided. Optionally, in this arrangement, the above-mentioned processor is used to run a program, where any one of the above-mentioned method for controlling display of multimedia data is executed when the above-mentioned program is running.

According to the arrangements of the present disclosure, there is also provided an arrangement of an electronic device, including a memory and a processor, the above-mentioned memory stores a computer program, and the above-mentioned processor is configured to run the above-mentioned computer program to execute any one of the above-mentioned method for controlling display of multimedia data.

According to the arrangements of the present disclosure, there is also provided an arrangement of a computer program product, when executed on a data processing device, the computer program product is adapted to perform a program initialized with any of steps of above-mentioned method for controlling display of multimedia data.

The serial numbers of the above-mentioned arrangements of the present disclosure are only for description, and do not represent the superiority of the arrangements.

In the above-mentioned arrangements of the present disclosure, the description of each arrangement has its own focus. For parts that are not described in detail in an arrangement, reference may be made to related descriptions of other arrangements.

Those skilled in the art will easily think of other arrangements of the disclosure after considering the specification and practicing the invention disclosed herein. This disclosure is intended to cover any variations, uses, or adaptive changes of the disclosure. These variations, uses, or adaptive changes follow the general principles of the disclosure and include common knowledge or conventional technical means in the technical field not disclosed in the disclosure. The description and the arrangements are only regarded as exemplary, and the true scope and spirit of the disclosure are pointed out by the following claims.

It should be understood that the disclosure is not limited to the precise structure described above and shown in the drawings, and various modifications and changes can be made without departing from its scope. The scope of the disclosure is only limited by the appended claims.

What is claimed is:

1. A method for controlling display of multimedia data, applied to an audience client-side, comprising:
receiving a plurality of multimedia data streams distributed by a server-side, wherein the plurality of multimedia data streams are data streams respectively provided by a plurality of anchor client-sides;
playing the plurality of multimedia data streams in a plurality of display areas of a graphical user interface, respectively, wherein, in a default display mode, each of the plurality of display areas is a preset ratio display area in the graphical user interface;
selecting a target multimedia data stream from the plurality of multimedia data streams, wherein the target multimedia data stream comprises one or more multimedia data streams; and
adjusting the default display mode to a target display mode based on the target multimedia data stream.

2. The method according to claim 1, wherein said selecting the target multimedia data stream from the plurality of multimedia data streams comprises:
in response to that a first control in the graphical user interface receiving a first touch operation, displaying a function setting interface, wherein the first control is independent of the plurality of display areas, and the function setting interface comprises a plurality of extended function controls; and
in response to that the a second control of the plurality of extended function controls receiving a second touch operation, selecting the target multimedia data stream, wherein the second control triggers a selection of the target multimedia data stream.

3. The method according to claim 1, wherein said adjusting the default display mode to the target display mode based on the target multimedia data stream comprises:
determining, from the plurality of display areas, a target display area corresponding to the target multimedia data stream and a non-target display area not corresponding to the target multimedia data stream; and
displaying the target display area in a full-screen display based on a display size of the graphical user interface, and hiding the non-target display area.

4. The method according to claim 3, further comprising:
playing the target multimedia data stream in the target display area in the target display mode, and stopping getting remaining data streams except for the target multimedia data stream from the server-side.

5. The method according to claim 1, further comprising:
in response to that a third control in the graphical user interface receiving a third touch operation, restoring the target display mode to the default display mode, wherein the third control triggers a determination of a display mode of the graphical user interface.

6. The method according to claim 1, wherein said selecting the target multimedia data stream from the plurality of multimedia data streams comprises:
in response to that a fourth control in any one of the plurality of display areas receiving a fourth touch operation, selecting the target multimedia data stream, wherein the fourth control triggers a selection of the target multimedia data stream.

7. The method according to claim 1, said adjusting the default display mode to the target display mode based on the target multimedia data stream comprises:
determining, from the plurality of display areas, a main display area corresponding to the target multimedia data stream and an auxiliary display area not corresponding to the target multimedia data stream; and
displaying the main display area in a full-screen display based on a display size of the graphical user interface, and displaying the auxiliary display area in a local window.

8. The method according to claim 7, further comprising:
playing the target multimedia data stream in the main display area in the target display mode, and playing a multimedia data stream corresponding to the auxiliary display area in the auxiliary display area.

9. The method according to claim 7, further comprising:
in response to that a fifth control in the auxiliary display area receiving a fifth touch operation, restoring the target display mode to the default display mode, wherein the fifth control triggers a determination of a display mode of the graphical user interface.

10. The method according to claim 7, wherein the local window is a slid-able window.

11. An electronic device, applied to an audience client-side, comprising:
a processor;
a memory for storing instructions executable by the processor;
wherein the processor is configured to:
receive a plurality of multimedia data streams distributed by a server-side, wherein the plurality of multimedia data streams are data streams respectively provided by a plurality of anchor client-sides;
play the plurality of multimedia data streams in a plurality of display areas of a graphical user interface, respectively, wherein, in a default display mode, each of the plurality of display areas is a preset ratio display area in the graphical user interface;
select a target multimedia data stream from the plurality of multimedia data streams, wherein the target multimedia data stream comprises one or more multimedia data streams; and
adjust the default display mode to a target display mode based on the target multimedia data stream.

12. The electronic device according to claim 11, wherein the processor is configured to:
in response to that a first control in the graphical user interface receiving a first touch operation, display a function setting interface, wherein the first control is independent of the plurality of display areas, and the function setting interface comprises a plurality of extended function controls; and
in response to that the a second control of the plurality of extended function controls receiving a second touch operation, select the target multimedia data stream, wherein the second control triggers a selection of the target multimedia data stream.

13. The electronic device according to claim 11, wherein the processor is configured to:
determine, from the plurality of display areas, a target display area corresponding to the target multimedia data stream and a non-target display area not corresponding to the target multimedia data stream; and
display the target display area in a full-screen display based on a display size of the graphical user interface, and hiding the non-target display area.

14. The electronic device according to claim 13, wherein the processor is further configured to:
play the target multimedia data stream in the target display area in the target display mode, and stopping getting remaining data streams except for the target multimedia data stream from the server-side.

15. The electronic device according to claim 11, wherein the processor is further configured to:
restore the target display mode to the default display mode, in response to that a third control in the graphical user interface receiving a third touch operation, wherein the third control triggers a determination of a display mode of the graphical user interface.

16. The electronic device according to claim 11, wherein the processor is configured to:
select the target multimedia data stream, in response to that a fourth control in any one of the plurality of display areas receiving a fourth touch operation, wherein the fourth control triggers a selection of the target multimedia data stream.

17. The electronic device according to claim 11, wherein the processor is configured to:
determine, from the plurality of display areas, a main display area corresponding to the target multimedia data stream and an auxiliary display area not corresponding to the target multimedia data stream; and
display the main display area in a full-screen display based on a display size of the graphical user interface, and displaying the auxiliary display area in a local window.

18. The electronic device according to claim 17, wherein the processor is further configured to:
play the target multimedia data stream in the main display area in the target display mode, and play a multimedia data stream corresponding to the auxiliary display area in the auxiliary display area.

19. The electronic device according to claim 17, wherein the processor is further configured to:
restore the target display mode to the default display mode, in response to that a fifth control in the auxiliary display area receiving a fifth touch operation, wherein the fifth control triggers a determination of a display mode of the graphical user interface.

20. A non-transitory computer-readable storage medium having instructions stored thereon, wherein when the instructions are performed by a processor, a method for controlling display of multimedia data is implemented,
wherein the method for controlling display of multimedia data comprises:
receiving a plurality of multimedia data streams distributed by a server-side, wherein the plurality of multimedia data streams are data streams respectively provided by a plurality of anchor client-sides;
playing the plurality of multimedia data streams in a plurality of display areas of a graphical user interface, respectively, wherein, in a default display mode, each of the plurality of display areas is a preset ratio display area in the graphical user interface;
selecting a target multimedia data stream from the plurality of multimedia data streams, wherein the target multimedia data stream comprises one or more multimedia data streams; and
adjusting the default display mode to a target display mode based on the target multimedia data stream.
